(19) United States
(12) Patent Application Publication
(10) Pub. No.: US 2025/0373720 A1
(43) Pub. Date: Dec. 4, 2025

(54) PIVOTING MEMBER WITH INTEGRATED HOOK FOR THE CASE OF A PORTABLE ELECTRONIC DEVICE

(71) Applicant: FELLOWES MOBILE LLC, Itasca, IL (US)

(72) Inventors: Xiao Guang Wang, Schaumburg, IL (US); Evan Michael Dorsel, Arlington Heights, IL (US)

(21) Appl. No.: 19/224,496

(22) Filed: May 30, 2025

Related U.S. Application Data
(60) Provisional application No. 63/653,568, filed on May 30, 2024.

(51) Int. Cl. H04M 1/06

(52) U.S. Cl. CPC H04M 1/06

(57) ABSTRACT

A case for protecting a portable electronic device such as a tablet, the case including a pivoting mount or member to allow the case to the attached to the headrest post of an automobile seat and allow the tablet display to be viewed by a passenger in a rear seat. The pivoting member has an open position and a closed position, and by be maintained in any position in-between. The pivoting member may include a channel or channels to allow the member to be hooked onto or otherwise attached to the headrest post. The pivoting member may include a handle feature and may act as a kickstand. In some embodiments, the pivoting member may be adhesively attached to a component of the case.

### CROSS-REFERENCE TO RELATED APPLICATIONS

This is a non-provisional application claiming priority to U.S. Provisional Application No. 63/653,568, filed May 30, 2024, which is incorporated herein by reference.

### BACKGROUND OF THE INVENTION

Cases for portable electronic devices such as tablets are well known. The cases generally include a main body that includes material to provide impact protection for the portable electronic device. Some cases, particularly those for children, may include a pivoting handle that allows the user to grasp and carry the case more easily, as well as provide a kickstand to support the tablet in an upright viewing position when pivoted. The tablets are often used to provide entertainment content to children, particularly when traveling in an automobile. It is therefore advantageous to provide a case that includes features that provide protection to the electronic device, provide a way to grasp the case, provide a kickstand feature to prop the case at a convenient viewing angle, and provide a mount to attach the case to a feature in an automobile to allow viewing of the device by children who often ride in the rear seats, among other features.

### FIELD OF THE INVENTION

The invention relates to protective cases for portable electronic devices such as tablets.

### BACKGROUND ART

Protective cases for portable electronic devices are well known in the art. The cases feature a body of impact absorbing material to protect the device the case is designed to hold. The cases of the prior art may also include a pivoting handle which may act as a kickstand.

### SUMMARY OF THE INVENTION

The invention is a protective case for a portable electronic device that includes a pivoting mount to allow the case to the removably attached to a feature of an automobile. More particularly, the case, via the pivoting mount, may be attached to a post that connects a headrest to a seat.

The pivoting mount is generally thin and planar to allow the mount to fit between the seat and headrest even when the headrest is not extended or deployed from its minimum position above the seat. The thin aspect of the mount also allows the mount to be stored flat against a surface of the case when not in use and reduces the overall bulk of the case.

The mount may include a channel or a plurality of channels to engage a post or posts of the headrest. The channels may include bends to allow the mount to hook onto the posts of the headrest.

In some configurations, the mount may include adhesive to be attached to an existing tablet case rather than being formed as part of a case. Such an embodiment may attach to the main body of the case, or to a pivoting member of the case, such as a pivoting handle.

In one form, the invention is directed to a case for a portable electronic device. The case includes a main body for receiving the external housing of the portable electronic device and a pivoting member pivotably attached to the main body. The pivoting member has a first end, a central portion, and a second end. The first end includes a hook.

In one form, the second end includes a handle.

In one form, the pivoting member is pivotably attached to the case at the central portion.

In one form, the first end is planar and the handle includes an aperture.

The aperture has an axis perpendicular to the plane of the first end.

In one form, the first end is planar.

In one form, the hook is a channel in the first end.

In one form, the channel includes a first portion and a second portion.

In one form, the first portion is at an angle to the second portion.

In one form, the angle is 90 degrees.

In one form, the channel includes a mouth. The mouth is on a lateral edge of the first end.

In one form, an axis of the first portion of the channel is parallel to an axis of rotation of the pivoting member.

In one form, an axis of the second portion of the channel is perpendicular to an axis of rotation of the pivoting member.

In one form, the channel includes a mouth. The mouth has tapered walls.

In one form, the pivoting member has a closed position. When in the closed position, an interior surface of the first end rests on a back wall of the case.

In one form, the pivoting member has a fully open position. When in the fully open position, the handle contacts a front surface of the case.

In one form, the pivoting member is restricted from rotating by detents.

In one form, the detents hold the pivoting member at positions intermediate to fully open and fully closed.

In one form, the second portion has a protrusion that extends into the channel. The protrusion is resilient.

In one form, the second end has a thickness equal to the thickness of the case. The first end is planar and is thinner than the second end.

In one form, the hook is formed within the first end.

### BRIEF DESCRIPTION OF THE DRAWINGS

FIG. 1 is a back perspective view of an embodiment of the invention with the pivoting member in a closed position.

FIG. 2 is a front perspective view of an embodiment of the invention with the pivoting member in a closed position.

FIG. 3 is a back elevational view of an embodiment of the invention with the pivoting member in a closed position.

FIG. 4 is a right side elevational view of an embodiment of the invention with the pivoting member in a closed position.

FIG. 5 is a left side elevational view of an embodiment of the invention with the pivoting member in a closed position.

FIG. 6 is a bottom elevational view of an embodiment of the invention with the pivoting member in a closed position.

FIG. 7 is a front elevational view of an embodiment of the invention with the pivoting member in a closed position.

FIG. 8 is a top elevational view of an embodiment of the invention with the pivoting member in a closed position.

FIG. 9 is a back perspective view of an embodiment of the invention with the pivoting member in an open position.

FIG. 10 is a front perspective view of an embodiment of the invention with the pivoting member in an open position.

FIG. 11 is a back elevational view of an embodiment of the invention with the pivoting member in an open position.

FIG. 12 is a right side elevational view of an embodiment of the invention with the pivoting member in an open position.

FIG. 13 is a left side elevational view of an embodiment of the invention with the pivoting member in an open position.

FIG. 14 is a bottom elevational view of an embodiment of the invention with the pivoting member in an open position.

FIG. 15 is a front elevational view of an embodiment of the invention with the pivoting member in an open position.

FIG. 16 is a top elevational view of an embodiment of the invention with the pivoting member in an open position.

FIG. 17 is a back perspective view of an embodiment of the invention with the pivoting member in a closed position.

FIG. 18 is a front perspective view of an embodiment of the invention with the pivoting member in a closed position.

FIG. 19 is a back elevational view of an embodiment of the invention with the pivoting member in a closed position.

FIG. 20 is a right side elevational view of an embodiment of the invention with the pivoting member in a closed position.

FIG. 21 is a left side elevational view of an embodiment of the invention with the pivoting member in a closed position.

FIG. 22 is a bottom elevational view of an embodiment of the invention with the pivoting member in a closed position.

FIG. 23 is a front elevational view of an embodiment of the invention with the pivoting member in a closed position.

FIG. 24 is a top elevational view of an embodiment of the invention with the pivoting member in a closed position.

FIG. 25 is a back perspective view of an embodiment of the invention with the pivoting member in an open position.

FIG. 26 is a front perspective view of an embodiment of the invention with the pivoting member in an open position.

FIG. 27 is a back elevational view of an embodiment of the invention with the pivoting member in an open position.

FIG. 28 is a right side elevational view of an embodiment of the invention with the pivoting member in an open position.

FIG. 29 is a left side elevational view of an embodiment of the invention with the pivoting member in an open position.

FIG. 30 is a bottom elevational view of an embodiment of the invention with the pivoting member in an open position.

FIG. 31 is a front elevational view of an embodiment of the invention with the pivoting member in an open position.

FIG. 32 is a top elevational view of an embodiment of the invention with the pivoting member in an open position.

FIG. 33 shows the invention functioning as a kickstand to support the case at a selected viewing angle on a horizontal surface.

FIG. 34 shows the invention in an open position and hooked onto the headrest post of a car seat, allowing viewing of the device by a back seat passenger.

FIG. 35 is a view of the invention in an open position and hooked onto the headrest post of a car seat, allowing viewing of the device by a back seat passenger.

FIG. 36 is a closeup view of invention in an open position and hooked onto the headrest post of a car seat.

FIG. 37 is a closeup view of invention in an open position and hooked onto the headrest post of a car seat.

FIG. 38 is a front perspective view of the invention in an open position and hooked onto the headrest post of a car seat.

FIG. 39 is a front perspective view of the invention in an open position and hooked on the headrest post of a car seat.

FIG. 40 is a closeup top perspective view of the invention in an open position hooked onto the headrest post of a car seat.

FIG. 41 is a perspective view of the invention in an open position hooked onto the headrest post of a car seat.

FIG. 42 is a closeup top perspective view of the invention in an open position hooked onto the headrest post of a car seat, with the headrest in a lowered position.

FIG. 43 is a perspective view of the invention in an open position hooked onto the headrest post of a car seat with a child's car seat facing the device display.

### DETAILED DESCRIPTION OF THE PREFERRED EMBODIMENT

With reference to the Figures, disclosed herein is a pivoting member 100 or mount for attaching case 10 for a tablet to a post 270 of an automobile seat. The pivoting member may be used to attach other objects to other structures in instances where the pivoting member 100 is attached to the other objects.

In the examples shown in the Figures, a pivoting member 100 or mount is attached or held by the main body 11 of a case 10 for an electronic device. The case includes perimeter walls 8 and a back wall 9 spanning between the perimeter walls 8, thereby forming a well 7 for receiving a portable electronic device.

The pivoting member 100 includes a first end 101 and a second end 102. The respective ends defining a portion of the pivoting member 100 rather than a terminal edge of the pivoting member 100. In some embodiments, the first end 101 includes a thin flat portion 105. The first end 101 may include a flat or planar exterior surface 110 and a similar flat or planar interior surface 111. The interior and exterior surfaces are with reference to the position of the surfaces when the pivoting member 100 is in a stowed position.

The second end 102 may include a thick portion 106 when compared to the first end 101. The second end 102 may include a handle 115. The thick portion 106 is generally as thick as the case 10 main body 11. The pivoting member 100 may include a central portion 108.

The pivoting member 100 is pivotably attached to the main body 11 at a location between the first end 101 and the second end 102. In some embodiments, the pivoting member 100 is pivotably attached to another structure at the central portion 108. The first end 101 extends away from the central portion 108 a greater distance than the second end 102 extends away from the central portion 108.

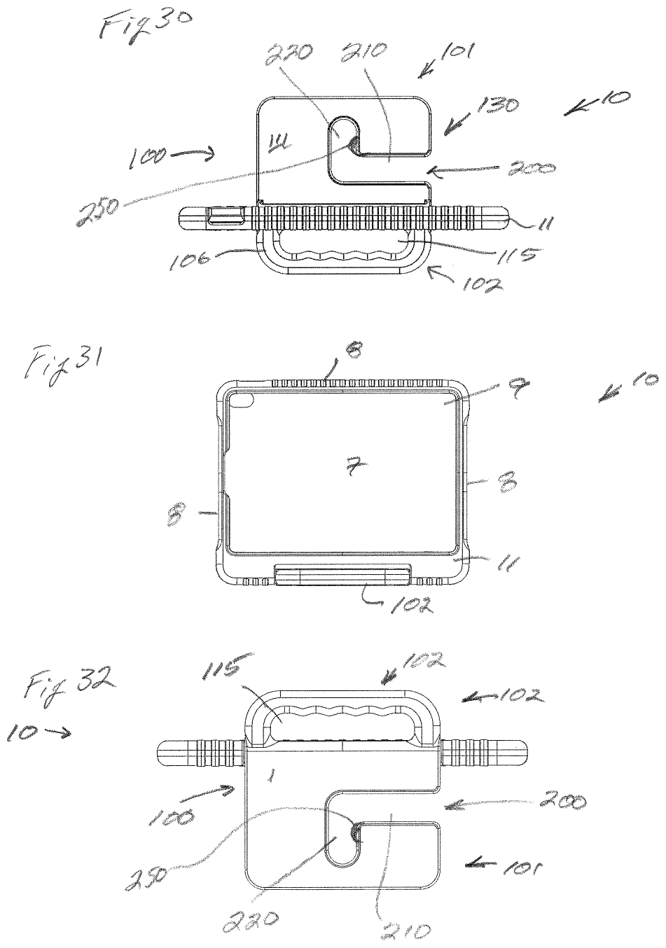

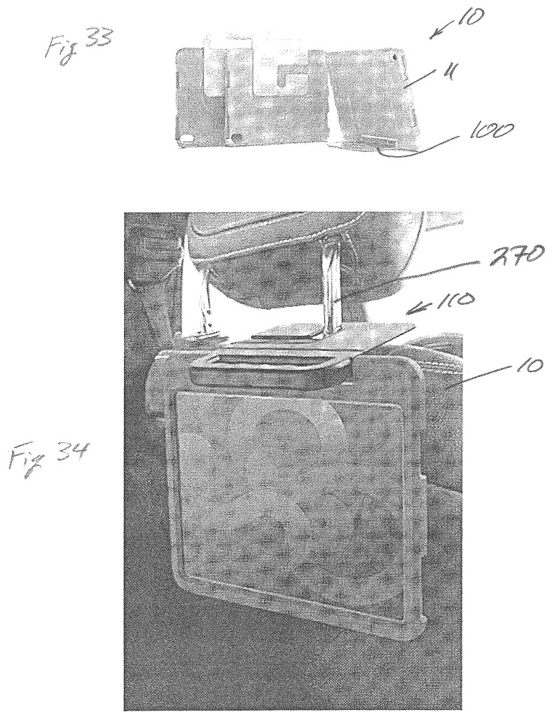

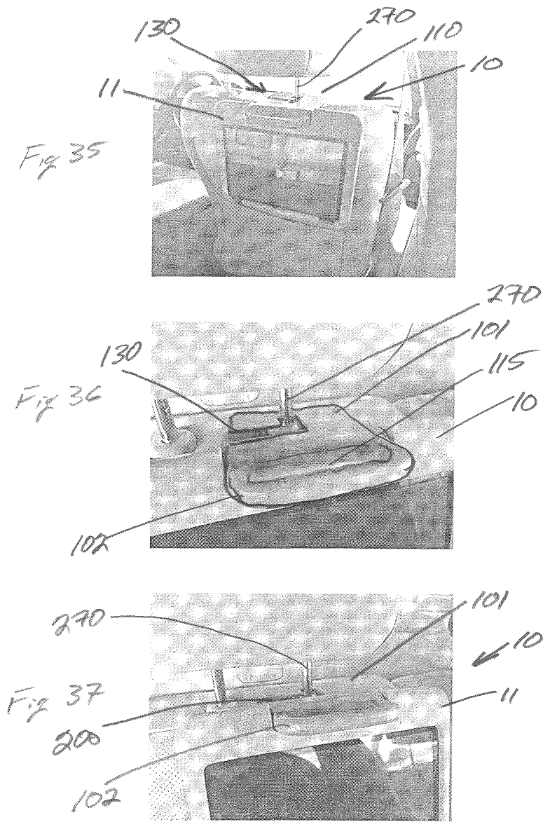

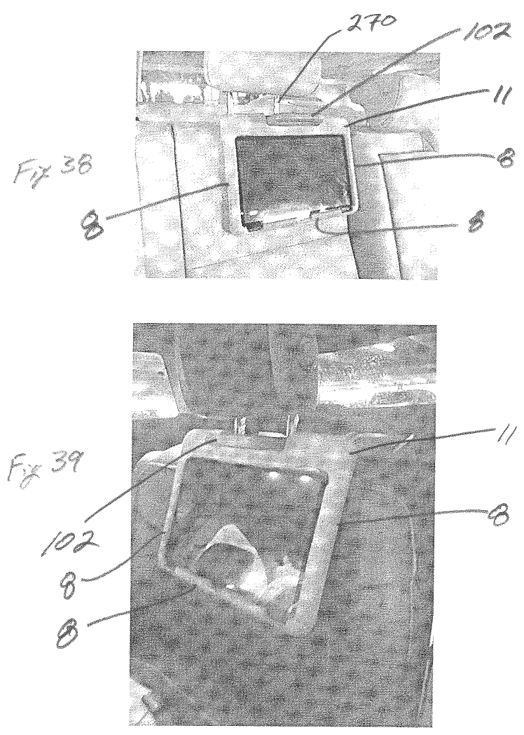

In some embodiments, the pivoting member 100 is attached to the main body at or near a perimeter wall 8 of the main body 11. In the preferred embodiment, the exterior surface 112 of the planar surface 110 is even with the perimeter edge of the main body 11 when the pivoting member 100 is perpendicular to the case, as shown in FIGS. 9-16 and 25-32

In some embodiments, the thin flat portion 105 is oriented parallel to the axis of rotation of the pivoting member 100. The thin flat portion 105 may include an integrated hook 130. The hook 130 can be used to support the case 10 and the electronic device contained in the case 10. This pivoting member 100 may also contain an integrated handle 115 feature.

By pivoting, the pivoting member 100 is able to assume different positions with respect to the main body 11. The range of rotation of the pivoting member 100 is limited by its contact with the main body 11 or other structures of the case 10. In some embodiments the first limit is reached when the handle portion 115 contacts a front surface 131 of the case 10 or tablet. The second limit is when the interior surface 111 contacts the back surface 132 of the case 10. The invention may include friction, or detent features to retain the pivoting member 100 in some or all of these positions. The friction features may be located between the pivoting member 100 and the body of the case. One skilled in the art will recognize that other intermediate limits or end limits may also be constructed using interfering elements on the case main body 11 and opposing portions of the pivoting member 100. Detents, friction, or other structures may be used to create intermediate stops or positions in the rotation of the pivoting member 100. One skilled in the art will recognize that a friction will allow an infinite number of stops or positions between the end limits. Intermediate positions allow the first portion 101 or second portion 102 to be used as a kick stand to incline the case 10 main body 11 above a work surface. The intermediate positions may also allow the user to adjust the angle of the main body 11 of the case with respect to a car seat for improved viewing when the hook is used to position the case from a headrest post 270.

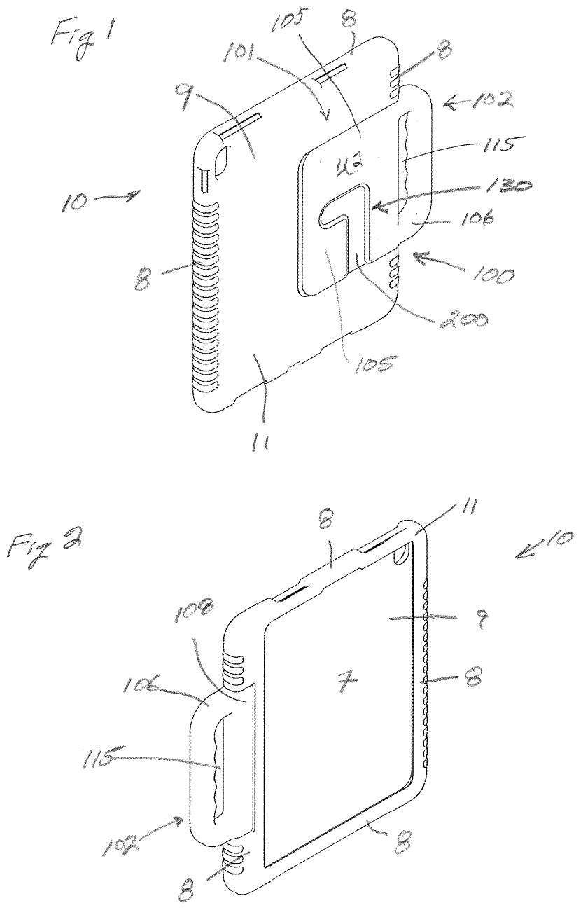

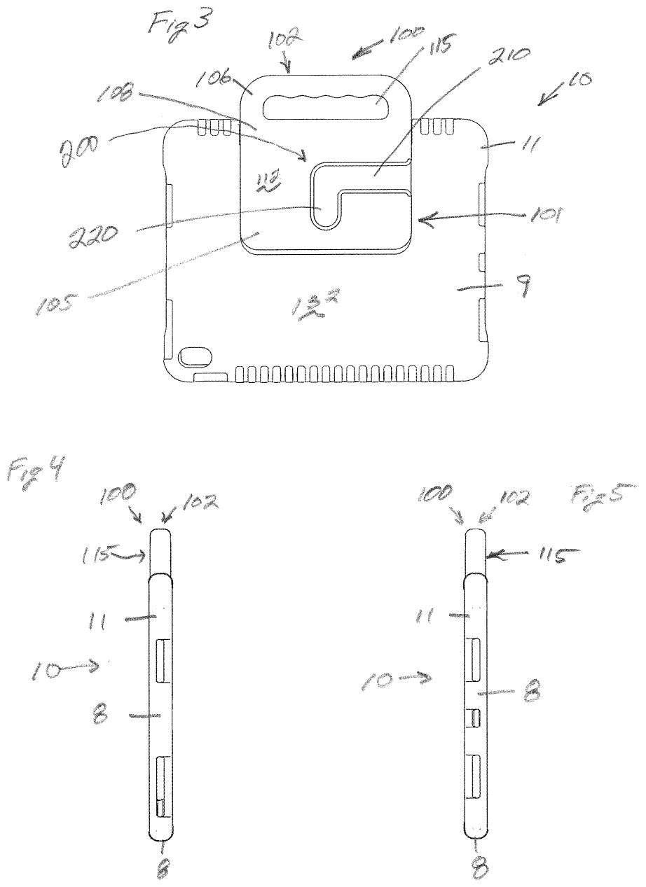

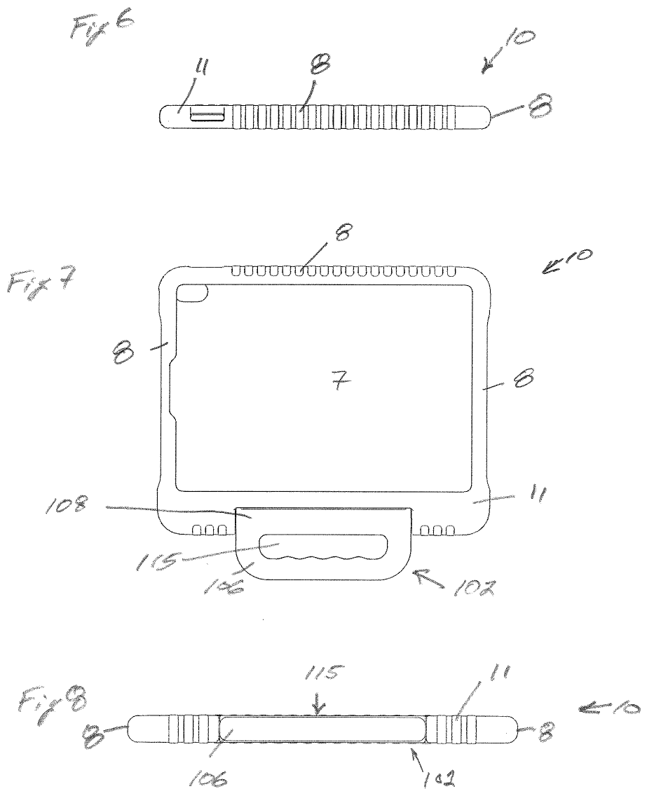

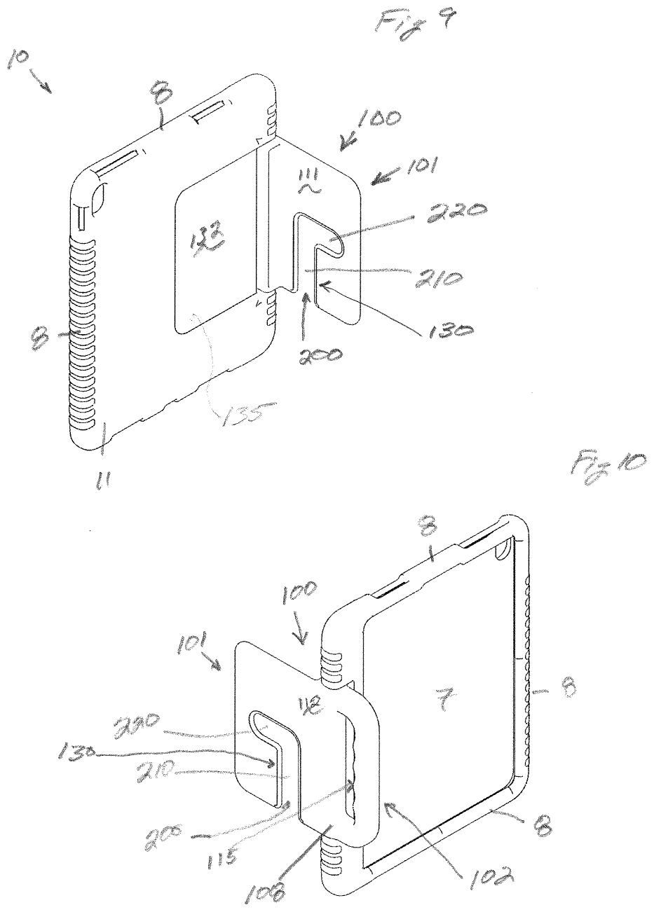

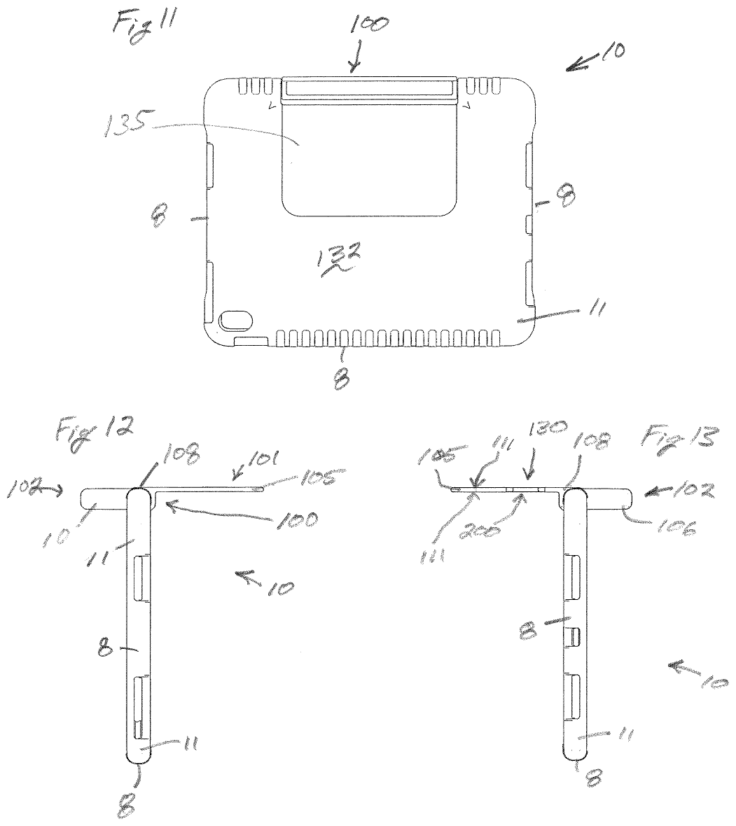

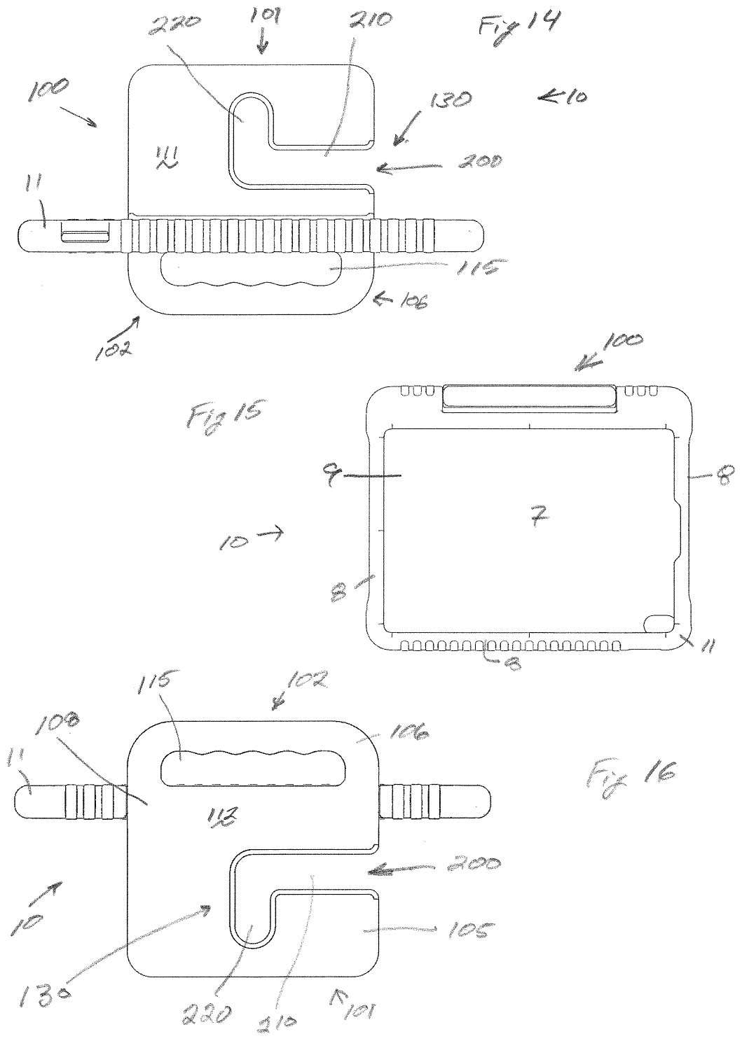

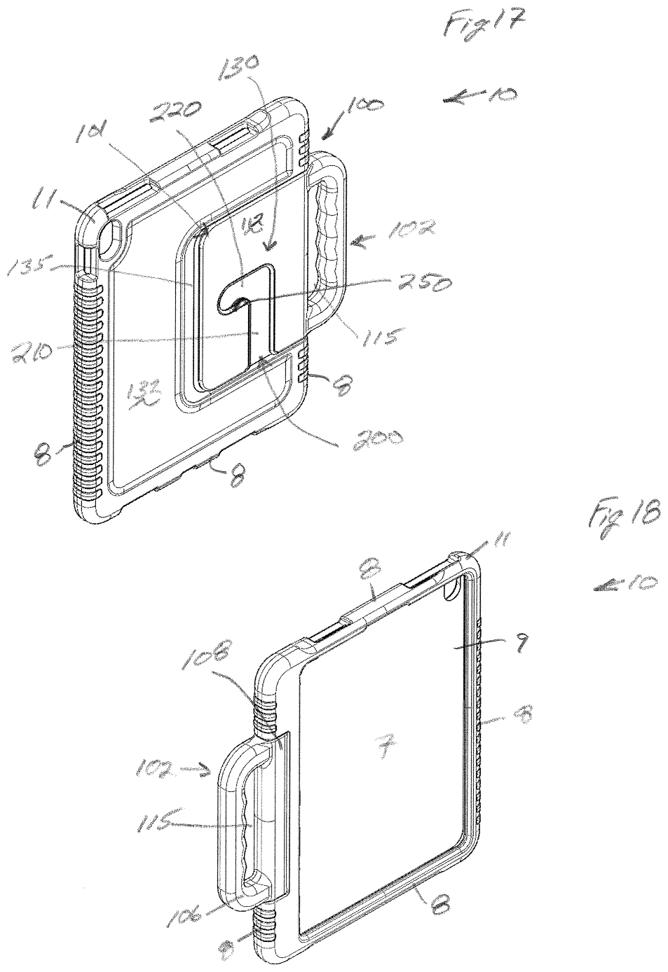

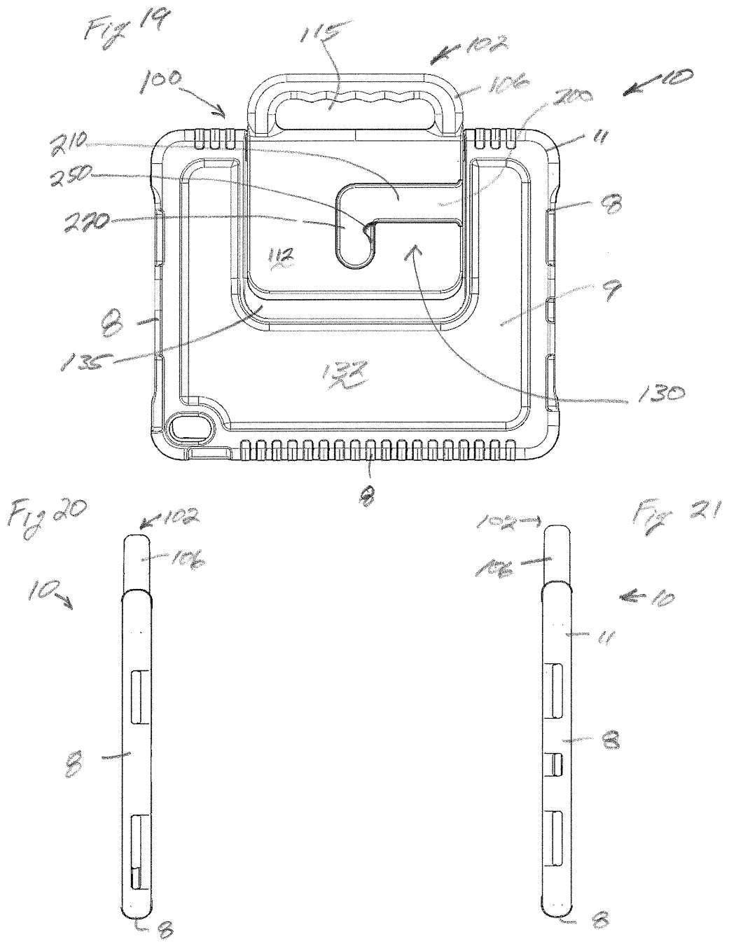

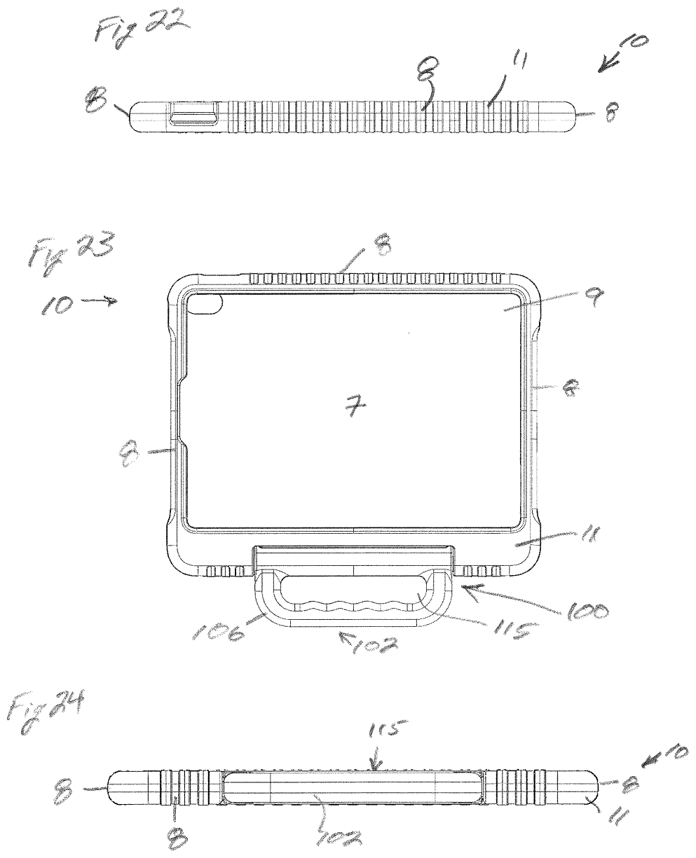

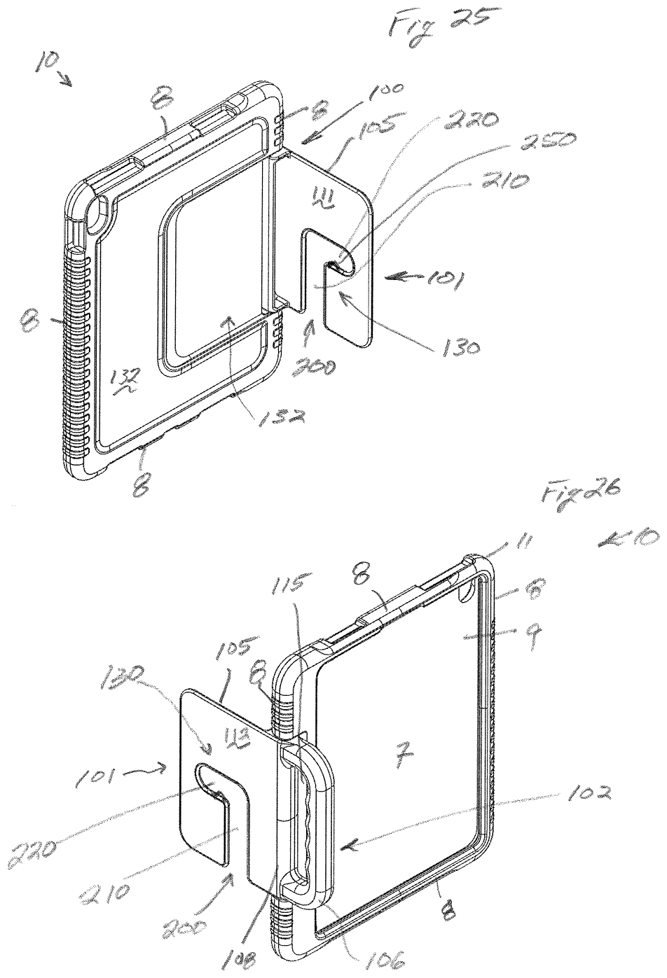

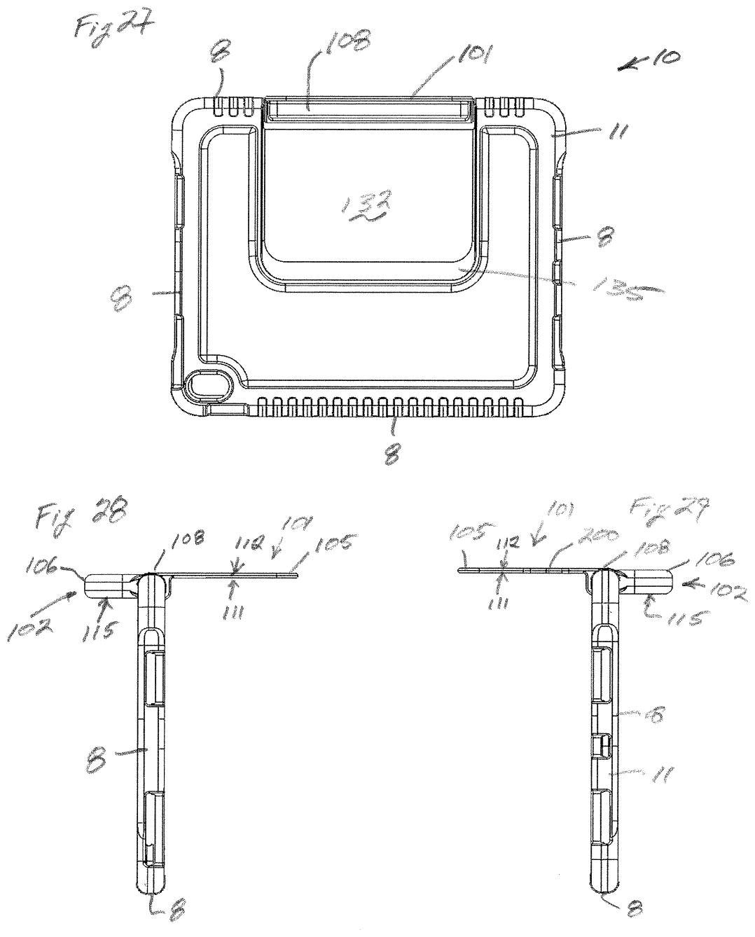

In some embodiments, one of these positions of the pivoting member 100 is the closed position, as shown in FIGS. 1-8 and 17-24. In the closed position, the pivoting member's interior surface 111 and the integrated hook contained therein are flush with or flat on the back surface 132 of the case 10 for the electronic device. The case 10 may include a recess 135 configured to receive some or all of the pivoting member 100 or to help access the pivoting member 100 for folding the pivoting member 100 out into a deployed position. In some configurations, an integrated handle may remain accessible while the pivoting member 100 is in the closed position.

In other embodiments, the pivoting member 100 may lie on the back surface 132 of the case or slightly displaced from the back surface 132 of the case 10 when in the closed position.

A second position of the pivoting member 100 is the fully open position, as shown in FIGS. 9-16 and 25-32. By folding pivoting member 100 out from its closed position, the first end 101 and the flat or planar exterior surface 110 is angled away from the back surface of the case 10 for the electronic device. This position allows for access to the pivoting member's hook. The pivoting member 100 can also serve as a stand by the exterior surface 112 or some edge of the pivoting member 100 being rested on a table or other surface to hold the case 10 and electronic device at a desired angle. The angle of the pivoting member 100 to the back of the case may vary depending upon the viewing angle desired by the user.

In one configuration, the main body 11 of the case 10 for the electronic devices is made from EVA foam and the pivoting member 100 is made from polycarbonate.

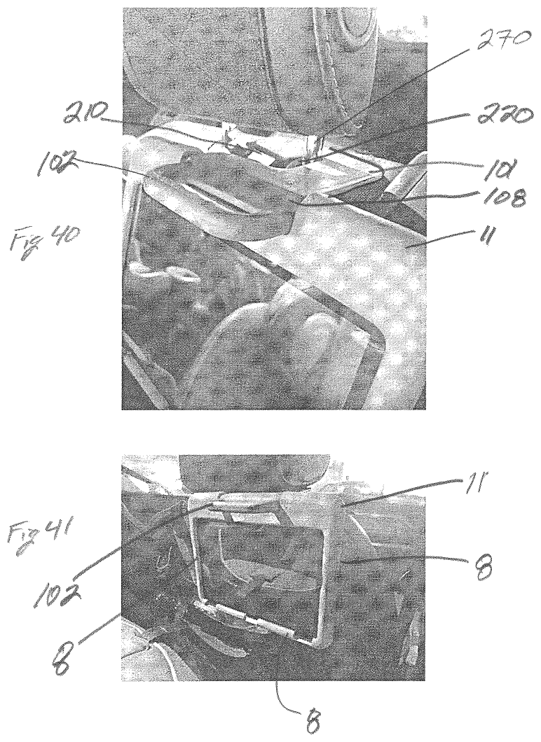

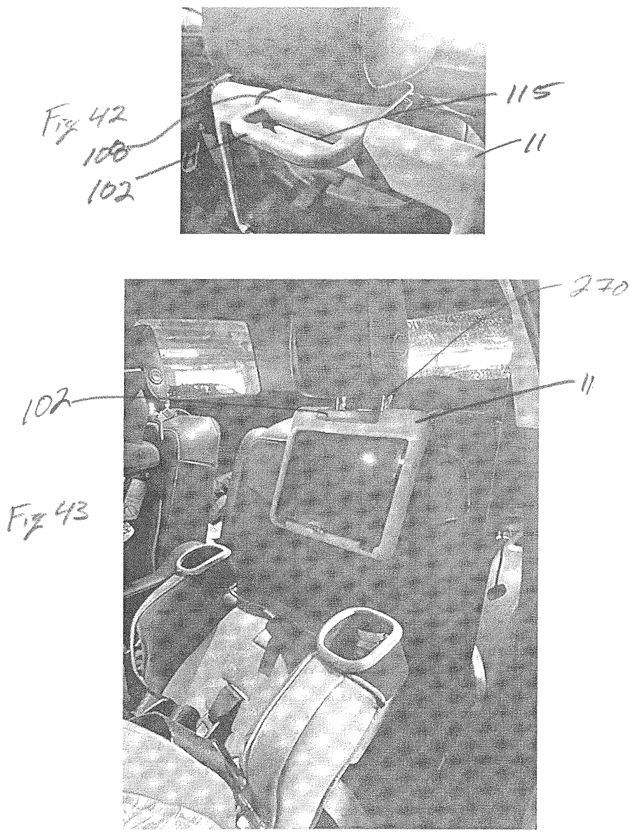

In some embodiments, the hook 130 is engaged with the vertical posts of a car headrest, as shown in FIGS. 34-43. The pivoting member's hook 130 can be hooked or engaged onto the vertical posts 270 of a front seat, holding the device up for viewing by a user sitting in the back seat. The pivoting member 100 can also be hooked onto the vertical posts 270 of the headrest for a rear car seat containing a backwards child car seat with the device facing the user in the child car seat.

The hook 130 or hooks if more that one hook is present on the pivoting member 100 may be formed by a channel 200 or plurality of channels in the pivoting member 100. The channel 200 may be wide enough to accept the headrest posts of the seat. The channel 200 may be in communication with the outside, so that the post 270 may be placed into the channel to secure the pivoting member 100 to the post. The channel 200 may include bends to prevent dislodgement of the pivoting member 100 from the post 270. The channel 200 has at least one axis, the at least one axis lying in the plane of the first end of the pivoting member 100. Such an axis is generally equidistant from the channel walls and is considered a primary axis of a channel.

In the embodiment shown in the figures, the channel 200 has an “L” shape, but other configurations and bends may be used. In some embodiments, the channel 200 may include a first portion 210 that is parallel to the axis of rotation of the pivoting member 100, and a second portion 220 that is not parallel to the axis of rotation of the pivoting member 100. The first portion 210 and the second portion 220 of the channel 200 may be of the same width. In other embodiments, the width of the portions of the channel may be different. For instance, the width of the first portion 210 of the channel 200 may be wider to improve the ease of engagement with the post 270. In such an embodiment, it is preferable to have the first portion 210 taper in width so that it is wider toward the mouth of the channel 200. In other embodiments, the second portion 220 is narrower toward the end of the channel, so that the channel walls may contact the sides of the post 270 to better prevent free play and movement of pivoting member 100 and hence the case 10 when attached to the seat. In some embodiments the second portion 220 of the channel may include a protrusion 250 into the channel. Such a protrusion 250 may allow the post 270 to snap into the end of the channel. In some embodiments, the protrusion 250 may be resilient and move, compress, or otherwise yield to allow passage of the post 270. The protrusion 250 may provide resistance to the post 270 moving in the channel. The first portion 210 may also include a protrusion.

In some embodiments, the second portion 220 is perpendicular to the axis of rotation, and extends away from the axis of rotation and from the first portion of the channel. Put another way, the second portion 220 of the channel 200 extends away from the first portion 210 towards a first end terminal edge of pivoting member 100.

The foregoing disclosure of specific embodiments is intended to be illustrative of the broad concepts comprehended by the invention.

1. A case for a portable electronic device, the case including a main body for receiving the external housing of the portable electronic device, a pivoting member pivotably attached to the main body, the pivoting member including a first end, central portion, and a second end, the first end including a hook.

2. The case of claim 1, wherein the second end includes a handle.

3. The case of claim 1 wherein the pivoting member is pivotably attached to the case at the central portion.

4. The case of claim 2 wherein the first end is planar and the handle includes an aperture, the aperture having an axis perpendicular to the plane of the first end.

5. The case of claim 1 wherein the first end is planar.

6. The case of claim 1 wherein the hook is a channel in the first end.

7. The case of claim 6 wherein the channel includes a first portion and a second portion.

8. The case of claim 7 wherein the first portion is at an angle to the second portion.

9. The case of claim 8 wherein the angle is 90 degrees.

10. The case of claim 6 wherein the channel includes a mouth, the mouth being on a lateral edge of the first end.

11. The case of claim 6 wherein an axis of the first portion of the channel is parallel to an axis of rotation of the pivoting member.

12. The case of claim 6 wherein an axis of the second portion of the channel is perpendicular to an axis of rotation of the pivoting member.

13. The case of claim 7 wherein the channel includes a mouth, the mouth having tapered walls.

14. The case of claim 1, wherein the pivoting member has a closed position and when in the closed position an interior surface of the first end rests on a back wall of the case.

15. The case of claim 1 wherein the pivoting member has a fully open position and when in the fully open position the handle contacts a front surface of the case.

16. The case of claim 1 wherein the pivoting member is restricted from rotating by detents.

17. The case of claim 16 wherein the detents hold the pivoting member at positions intermediate to fully open and fully closed.

18. The case of claim 7 wherein the second portion includes a protrusion extending into the channel, the protrusion being resilient.

19. The case of claim 2 wherein the second end has a thickness equal to the thickness of the case, and the first end is planar and is thinner than the second end.

20. The case of claim 1, wherein the hook is formed within the first end.
